(19) United States
(12) Patent Application Publication
(10) Pub. No.: US 2024/0236633 A1
(43) Pub. Date: Jul. 11, 2024

(54) INDIVIDUAL IDENTIFICATION AND INFORMATION SYSTEM

(71) Applicants: Jahangir NAKRA, Titusville, NJ (US); Yezad Jahangir William NAKRA, Titusville, NJ (US); Anna Roshen Gwynne NAKRA, Titusville, NJ (US)

(72) Inventors: Jahangir NAKRA, Titusville, NJ (US); Yezad Jahangir William NAKRA, Titusville, NJ (US); Anna Roshen Gwynne NAKRA, Titusville, NJ (US)

(21) Appl. No.: 18/404,782

(22) Filed: Jan. 4, 2024

Related U.S. Application Data
(60) Provisional application No. 63/437,473, filed on Jan. 6, 2023.

(51) Int. Cl. H04W 4/80; H04W 12/33

(52) U.S. Cl. CPC H04W 4/80; H04W 12/33

(57) ABSTRACT

An identification aide system that provides pertinent information to responders such as caregivers, first responders, medical personnel, emergency services and/or police/law enforcement to reduce the diagnosis time and provide correct treatment to an individual potentially experiencing a medical event, using wireless, contact-free identification and exchange of information. A wearable device worn by the individual broadcasts a unique ID that is tied to the medical and/or non-medical records of the individual. In the presence of the wearable device, a portable device provides the authenticated responder with pertinent information of the individual that can aide in the rapid diagnosis of the condition and expedite resolution of the situation. The system enables law enforcement to identify individuals with special needs when encountered, enabling the law enforcement to react appropriately with the knowledge of the individual's condition.

### CROSS REFERENCE

This application claims priority to U.S. provisional application No. 63/437,473 filed Jan. 6, 2023, the entire disclosure of which is incorporated herein by reference for all purposes.

### FIELD OF THE DISCLOSURE

The present disclosure is directed to a wireless identification aide system which provides first responders, emergency service and other medical personnel with information to reduce the diagnosis time, reduce uncertainty, and provide appropriate treatment/intervention to a person in need.

### BACKGROUND

The number of individuals diagnosed as developmentally disabled, with aliments such as autism spectrum disorders (ASD), has been rising; developmentally disabled individuals also include those with Down syndrome, Asperger's, cerebral palsy, Fragile X syndrome, ADD/ADHD, cognitive challenges, etc. There are also individuals who have regressive conditions such as Alzheimer's. Many of these individuals, as well as many other individuals with other conditions, are incapable of effectively and completely communicating one or more of their medical conditions or issues to emergency personnel and/or medical professionals and/or caregivers.

Any of these above-identified individuals may be incapable of communicating potential health related details (e.g., allergies, chronic pain, etc.) because of their conditions, or may be incapacitated for a reason other than their ailments, such as being in an accident, having an aphylactic reaction, having an epileptic seizure, etc.

### SUMMARY

The present disclosure provides a system that provides first responders, emergency service and/or law enforcement personnel as well as caregivers and/or medical professionals contact-free data sharing of patient health information, which can reduce the diagnosis time and/or help with rapid assessment of the situation at hand and enable correct treatment of the individual. The system can also aid law enforcement responding to an incident to be alerted to one or more individuals associated with the incident that might have pre-existing medical conditions, thus enabling the law enforcement to react appropriately knowing the individual's medical complications.

The system includes a device, either worn by or connected to the individual, that has electronic circuitry that broadcasts wirelessly a unique ID, the ID being tied to medical and non-medical records of the individual. As a first responder, law enforcement, emergency responder or other authorized person approaches the individual, an application on a portable device and/or computer quickly identifies the individual based in the ID and provides the response team with the appropriate information on the individual, such as how the individual should be treated/handled and potentially information on the individual's ailment including links to web sites that provide additional pertinent information.

This system provides the response team with much-needed information that can reduce the time for diagnosis and thus treatment of the individual with the correct medication, treatment, intervention, etc. The system can also be a repository for the exchange and/or sharing of the individual's information between caregivers and/or medical professionals.

In one particular embodiment, the system includes a wearable device, a receiver device (for example, a portable device such as a smartphone, tablet, headset, or a computer etc.), and a cloud server with two-way communication with the receiver device. An individual wears or is otherwise connected to one or more wearable devices, the wearable devices each having a unique ID representative of the individual. The individual's caregiver or a response team (e.g., police/law enforcement, emergency responders) has access to the receiver device that runs an application (an “app”) of the system to obtain information from the cloud server. The receiver device could be located at a fixed location, a mobile location, or be portable.

In another embodiment, the system comprises one or more wearable devices, a receiver device, and a cloud server. An individual wears or is otherwise connected to one or more wearable devices. The wearable devices include an active wireless transmitter, having the capability to actively transmit and/or provide interactive information to a cloud server, located remotely from the individual. The wearable devices use an established wireless communication network to identify the location of themselves and thus the individual and convey that information to the cloud server.

The wearable devices may be connected to or have built-in radio transceivers, including any additional hardware to recognize wireless protocols (such as Bluetooth, RFID or other wireless protocol). The wearable devices send wirelessly their ID to a receiver device, e.g., when requested or when in a predetermined distance from the receiver device. The wearable devices may be continuously emitting (sending) their ID or may only send their ID when initiated by a signal from a receiver device. The wearable devices may have communications capability to directly communicate with the system, such as wireless communication with the cloud server, e.g., to sends its location to the cloud server.

In an embodiment, wearable devices have built-in intelligence capability to detect individual conditions such as stress levels using GSR/GSC, pulse rate, rapid/jerky motion, and other sensing capabilities to detect individual distress. For example, Autistic meltdowns may be inhibited or prevented if the accumulating stress levels can be halted and reversed in the antecedent to the meltdown phase by detecting it early and alerting the responders and/or caretaker. The use of Artificial Intelligence (AI) and/or Machine Learning (ML) techniques and algorithms in the wearable devices can provide enhanced and accurate condition detection capabilities in addition to other benefits.

The receiver device may be connected to or have built-in radio transceivers, including any additional hardware to recognize wireless protocols (such as Bluetooth, RFID or other wireless protocol) emanating from the wearable device. The receiver device may also have wireless two-way communication with the cloud server, e.g., to download information pertinent to that individual identified by the ID. This information can be sent, by the receiver device, to a hospital/medical facility, as desired or required. The receiver device may be a portable device such as a smartphone, tablet, headset, or a computer (e.g., laptop computer). An augmented reality headset can be used to enhance the user's capabilities, interaction and experience.

In one embodiment, the disclosure provides a method for data entry process, data presentation process, direct and indirect sensor data capture processes, data analysis process, and data visualization process for the system. Any two or more of these processes can run concurrently. The system enables the caregiver/medical personnel to feed, edit, and/or add data to the individual's records as they deem necessary for the responders to effectively help the individual who might be in distress.

In another embodiment, the wearable device captures sensor data directly from the individual to which it is attached and transmits the sensor data to the system through the receiver device. The wearable device may capture sensor data autonomously without any intervention by the caregiver, medical provider or first responder. Alternately, sensor data capture can be initiated by a fixed time interval, when manually initiated, and/or when the wearable device detects an event that needs to be reported. There could be multiple combinations of trigger events and sustained data capture after a trigger event occurs. These direct and indirect sensor data capture processes could be run concurrently with data entry process, data presentation process, data analysis process, and data visualization process.

Any or all of the wearable device, the receiver device, or the cloud device could be enabled with Artificial Intelligence and/or Machine Learning capabilities. This capability can allow the receiver device to authenticate the responder and allow voice recognition of the responder. This capability would also allow the system to learn and derive conclusions based on the data collected by the system (including sensory data) as well as data available from other sources. The learning from this capability would be communicated to the responders to help them be more informed and take better care of the individual in distress.

These and various other features and advantages will be apparent from a reading of the following detailed description.

### BRIEF DESCRIPTION OF THE DRAWINGS

The figures presented are an example of the implementation and is not limited to those described herein. The disclosure may be more completely understood in consideration of the following detailed description of various embodiments of the disclosure in connection with the accompanying drawing, in which:

FIG. 1 is a schematic diagram of a wireless system of this disclosure.

FIG. 2 is a schematic diagram of another example of a wireless system.

FIG. 3 is a flow diagram of a data entry process of a wireless system of this disclosure.

FIG. 4 is a flow diagram of a data presentation process of a wireless system of this disclosure.

FIG. 5 is a flow diagram of a sensor data capture process of a wireless system of this disclosure using an indirect communication mechanism.

FIG. 6 is a flow diagram of another sensor data capture process of a wireless system of this disclosure using wearable devices with autonomous direct data transceiver capabilities.

FIG. 7 is a flow diagram of a data analysis and alerting process of a wireless system of this disclosure.

FIG. 8 is a flow diagram of a data visualization process of a wireless system of this disclosure.

FIG. 9 is a flow diagram of an edge device based on Artificial Intelligence/Machine Learning data exchange and responder interaction process of this disclosure.

FIG. 10 is a flow diagram of the backend Artificial Intelligence/Machine Learning and responder interaction process of this disclosure.

FIG. 11 is a schematic diagram of a computer system suitable for implementing one or more aspects of a system of this disclosure.

### DETAILED DESCRIPTION

This disclosure provides a system that can be used with any situation, condition or ailment where an individual is incapable of communicating one or more of their medical conditions or issues effectively to responders such as emergency personnel, medical professionals, or even caregivers. The individual may have an autism spectrum disorder (ASD), be developmentally disabled such as with Down syndrome, Asperger's, cerebral palsy, Fragile X syndrome, ADD/ADHD, Alzheimer's, other cognitive challenges, etc. Some of these individuals have often several challenges in common, including but not limited to speech and language impairments, cognitive deficits, social problems, behavioral problems, memory problems, attention deficit, and sensory processing dysfunction, etc. Alternately, the individual may be incapacitated or incapable of communicating due to unfortunate circumstances, e.g., due to an accident, having an aphylactic reaction, having an epileptic seizure, etc.

This system can be applied to any and all types of medical challenges that an individual might face. Using Autism as an example, in some cases, onset of conditions such as Autistic meltdowns can be one of the most challenging parts of life for an autistic person and his/her caregiver. Autistic meltdowns are triggered by being extremely frustrated or stressed, sometimes for reasons that might appear insignificant and hence unexpected to the non-autistic. Causes of autistic meltdowns include neurological and sensory overload, mounting frustrations over expectations to perform activities and behave within conventional norms, neurological difficulty adjusting to even minor deviations from routine, and failed attempts to be understood.

Autistic meltdowns may be prevented if the accumulating stress levels can be diminished and/or reversed. Upon detection of accumulating stress, mapping the instances of stress to the corresponding triggers would aid the caregiver and allow him or her to intervene and attenuate the triggers, thereby stopping the stress buildup. However, it is a challenge to detect the stress buildup leading to the meltdown phase. Signs of discomfort level and/or behavioral response to the stress-inducing triggers are most often hard to distinguish from their normal behaviors. Most of the existing methods to capture the causes of the autistic meltdown and dynamically provide timely interventions to prevent an autistic meltdown are often limited to health care or research in laboratories or medical facilities by trained specialists using a variety of distinct tools and methods. There is a need for in situ personalized care to predict and prevent episodes of autistic challenging behaviors.

The signs of discomfort level can vary from individual to individual. Parents, family members, friends, caregivers, medical personnel and therapists who spend time with such disabled persons develop their understanding of each individual's unique set of challenges and faculties. Disabled individuals require constant care and monitoring. They have difficulty communicating and can easily become lost if the caregiver's attention is only momentarily distracted. Since they often cannot communicate well, they are very difficult to locate, even when there is a public address system or other means of alerting others to their plight.

While Amber Alerts provide a public notification that alerts or notifies the public regarding a taken child and Silver Alerts provide a public notification that alerts or notifies the public regarding a missing person, a missing adult, or a missing elderly person afflicted with a condition such as Alzheimer's, Dementia, or other condition, these public notification systems are flawed in that they partially rely on members of the public to look out for and hopefully find the missing child or missing person. If the missing child or missing person becomes disoriented, falls ill, gets lost in an isolated area, becomes fearful, is unable to communicate, and/or tries to hide from others, the above-described public notification systems can be futile in finding the missing child or missing person.

Providing individuals of all ages with personal communication devices such as cellular telephones, personal digital assistants, or like communication devices, can also prove useless when the child or adult falls ill, panics, is unable to speak, becomes unconscious, or is otherwise unable to utilize such a personal communication device. Such conventional ways for a disabled individual to alert or notify emergency responders during such emergencies tend to be limited and have certain drawbacks. For example, the disabled individual needs to dial an emergency number. The disabled individual might not be able to relate to an emergency call center operator or dispatcher or to the responder or medical professional. These emergency call center operators or dispatchers and responders or medical professionals may attempt to obtain details about the type of emergency, the location of the person, details about the emergency, etc., but might be unsuccessful given the situation at hand. The dialing of the emergency number by itself does not indicate the type of emergency and is not directed to the appropriate entity that can respond to the emergency. As a result, this approach may tend to be slow in getting the alert to the entity that will respond. Moreover, this approach requires active involvement by the disabled individual experiencing the emergency and may not be effective when the disabled individual is unable to adequately describe the emergency.

Another conventional way for disabled individuals to alert or notify others during emergencies is via a subscription service having fixed point-to-point wired connections with health care providers as service providers. However, this is a wired connection and is generally not useful when disabled individuals are not at their residence, medical facility or otherwise able to access the fixed point-to-point connection. Moreover, this approach generally tends to be inflexible in that it only notifies the service provider.

Numerous attempts have been made to provide emergency location services for individuals.

U.S. Pat. No. 9,002,372 to Shakespeare et al. describes a locating system for autistic children due to their inability to communicate or because they are confused and disoriented. The apparatus comprises a cellular telephone unit that can be activated by an RF signal and which a child or patient can wear. The wearable unit can be activated by a caregiver's smartphone having a locating application installed therein. The locating application enables the caregiver to locate the lost person using radio direction finder triangulation when the lost person is within a few hundred feet of the caregiver. When the lost person is further away, the locating application employs cell phone tower triangulation or the wearable unit GPS/Assisted GPS application to determine the approximate location of the lost person. As the caregiver moves close enough to the approximate location, the radio direction finder triangulation is used to calculate a more exact location to find the lost person.

U.S. Patent application publication no. 2017/0316677 to Messier et al. provides wearable locator that has an ultra-low power RF transceiver, GPS receiver, cellular network RF transceiver, processor, programmable non-volatile memory, LCD display, accelerometer, and rechargeable battery.

U.S. Patent application publication no. 2014/0273912 to Peh et al. describes an emergency alert system that allows a user to configure a phone number to which an emergency alert is to be sent. The system also includes a touchscreen interface module to receive an indication from a user, through a touch screen display device, that the emergency alert is to be sent. The system also includes an emergency alert module coupled with the touchscreen interface module. The emergency alert module, in response to the indication, is to cause the emergency alert to be sent to the user-configured phone number through a wireless signal that is to be transmitted by an antenna.

U.S. Pat. No. 9,202,360 to Tedesco et al. provides a mobile terminal that is used to assist individuals with disabilities. A mobile terminal such as a “smartphone’, tablet, or another commercially available wireless handheld device may be loaded with software. The software can be configured to: (i) store criteria for managing the use of the mobile terminal and a remote caregiver and a second remote individual, (ii) determine whether a criterion is satisfied and if so (iii) initiate a communication from the mobile terminal to the remote caregiver, and (iv) initiate a second alert to the second remote individual via a second alert. Thus, through this Software, the mobile terminal may dynamically facilitate communications with specific remote caregivers based on specific situations that may confront disabled individuals.

U.S. Patent application publication no. 2016/0157074 to Joao et al. describes a wearable apparatus, including a housing; a pulse rate monitor, thermometer, or blood pressure monitor, which is separate and apart from the housing, which monitors and detects a physiological state of an individual; a Bluetooth device which transmits or enters information obtained by the pulse rate monitor, thermometer, or blood pressure monitor, to or into the apparatus; a global positioning device which determines a position or location of the housing; a camera or video recorder attached to, or located on, the housing; and a beacon attached to or located within the housing. The apparatus detects a physiological state indicating a healthcare need or a position or location of the housing outside of a safe zone of travel, establishes a communication link or a telephone call with a computer or a telephone, activates the camera or video recorder, and activates the beacon to facilitate locating the housing.

U.S. Patent application publication no. 2015/0258302 to Chandra et al. describes a personal and wearable device that includes a strap, which is worn by the user, and a remote controller, which is held by a guardian or a teacher. The strap includes a built-in heart rate monitor, a built-in accelerometer, and a built-in vibration motor, wherein the heart rate monitor and accelerometer are used to determine the current state of the child in real-time. The accelerometer is used to monitor any sudden or repeated actions of the arms or limbs of the user to determine whether the user is undergoing an outburst based on the magnitude of the measured acceleration in the arm; and the vibration motor may generate vibrations, which are adjustable in strength via the remote controller. The device is compact and convenient to carry, and thus provides a realistic solution for the integration of autistic persons into mainstream Schools, etc.

U.S. Patent application publication no. 2017/0340270 to Raghav Ganesh describes a method and apparatus to detect environmental triggers of stress and antecedent physiological stress symptoms of a patient, followed up with the delivery of a stress-relieving therapeutic response to the patient and a chronological report of events. The apparatus comprises a first device worn by the patient that contains sensors and can transmit and receive signals and a second device used by the caregiver that can transmit and receive signals. This integrated system continuously monitors environmental triggers and physiological stress indicative parameters of a patient diagnosed with autistic spectrum disorder, or other emotional or physical disorders, and compares these parameters against thresholds for the parameters.

However, each of these technologies has advantages and disadvantages. In most cases, the technologies available are (in a sense) looking for a problem to solve, rather than being an engineered solution to a specific problem such as a lost autistic child or Alzheimer's patient. As a result, few parents of autistic children have or use these products despite the near-constant fear of losing their child in a crowd. The present disclosure provides a system with features that overcome the deficiencies of the previously known systems, providing a wearable device, a portable receiver device (for example, smartphone, tablet, augmented reality headset, and/or other portable computing device with radio transceivers), and a computer and/or a cloud server. The wearable device is configured to be worn by or otherwise attached to an individual. The caregiver, police/law enforcement and/or emergency responders have the portable receiver device, which could be connected to or with built in radio transceivers with an application of the system that provides the individual's pertinent information that could be used to help the individual. Information provided by the system could be, e.g., medical records, current medication listing, proposed treatment options, other pieces of information that the individual might respond to such as addressing them a particular way, names of caregivers and/or doctors, means to identify the individual such as names and pictures, information on the individual's ailments including links to sites that provide additional pertinent information, etc. The information can be provided as audio, video, still images, text, alerts, visualization of data such as graphs, or in any manner that would benefit the responders and/or the individual themself. The portable receiver device could be used by caregivers and/or medical personnel to enter or edit pertinent information or data that is stored by the system either in the cloud server and/or on another computer. The emergency responder could use assisted GPS provided by the wearable device and track database to locate the individual.

When responders arrive at an active scene or incident, no matter how dispatched, quick assessment of the situation is critical. In many cases, the individual involved in the incident is unaware or incapable of conveying their situation and/or history. As an example, consider the case where an autistic individual is involved, and law enforcement officers are called to address the situation. Often the officers are commanding the individual to comply; for an individual with autism, this is counterintuitively provoking the individual to react in a manner inconsistent with what the officer has requested, causing the situation to escalate and possibly get out of control. Such a scenario is unfair to both parties involved, the autistic person for not being able to comprehend and for the officers for not knowing about the individual and the individual's medical condition. Consider another situation as an example, where a patient has some other ailment, such a diabetes or epilepsy, although unknown to the emergency response personnel. If this person faints or goes into a coma, as is not rare for those with diabetics, before the emergency response personnel can treat the coma, they need to spend precious time diagnosing the individual's condition and then acting on it. If the response personnel already knew that the individual was diabetic, they could immediately treat the coma, rather than having to also diagnose the cause of it.

As indicated above, the system of the present disclosure provides caregivers, police/law enforcement, and emergency responders with the identification of individuals with potential medical conditions as well as any other pertinent information recorded in the system that would aide in the diagnosis and treatment of a condition manifesting itself. The system includes, at least, a wearable device having a unique ID identifying the individual and a transmitter to send the unique ID, a receiver device configured to receive the unique ID from the wearable device, and a computer system (e.g., server) configured to provide to the receiver device the information tied to that unique ID.

One or more wearable device could be used for any individual that needs to or should be identified. The wearable device worn by the individual(s) is authenticated by the system, e.g., by one or both of the receiver device and the computer system. The system possesses the capability to identify an individual when presented with one or more wearable device IDs associated with that given individual. Additionally, the caregiver, medical personnel, police/law enforcement, emergency responders, etc., anyone who can access the records, are also authenticated. The system transfers data about the individual through wireless data communication, between the wearable device, the receiver device, and the computer system. No physical contact is needed between the individual and the responder. The system could acknowledge and interrogate the wearable device until all necessary data is collected and analyzed, including ID, location, and recent sensor data. The information pertaining to the individual is then presented to the responder to be used to effectively treat the individual. This system could also be used as a repository for information or data exchange about the individual between responders, caregivers and/or medical personnel.

In the following description, reference is made to the accompanying drawing that forms a part hereof and in which are shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

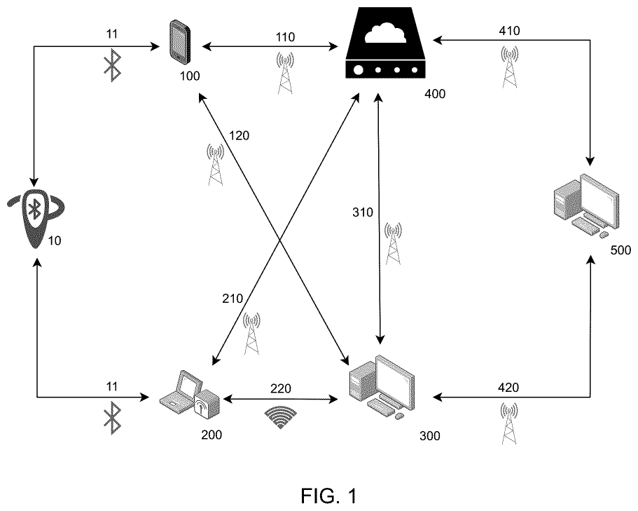

FIG. 1 illustrates a schematic diagram of a wireless system that can include any or all of a wearable device 10, a portable device 100, a computer 200 which could be connected to radio transceivers, a computer 300, a cloud server 400, and a computer system 500. The portable device 100 and/or the computer 200 are configured to receive a signal from the wearable device 10, and are also configured to receive a signal with pertinent information/data about the individual from the cloud server 400 and/or the computer 300. The computer system 500 can be a computer, portable device, smartphone, tablet, etc. and can be utilized by the caregiver and/or medical personnel to enter or append or edit the pertinent information/data.

As indicated, the wireless system has the wearable device 10 associated with an individual, the device 10 physically configured to be worn by or attached to the individual. The wearable device 10 has the capability of actively and wirelessly transmitting a unique and distinguishable ID, and has the capability to gather sensor data and actively transmit and/or provide interactive information to the portable device 100 or to the computer 200 connected to or with built-in radio transceivers that are located remotely from the individual and the wearable device 10. The portable device 100 and the computer 200 are operated by caregivers, medical personnel, police/law enforcement, and/or emergency responders. The system also includes one or both of a computer 300 and a cloud server 400, each which has communications capabilities (wireless or otherwise).

The wearable device 10 has a unique ID and uses an established wireless communication network 11 to identify the individual and/or optionally identify the location of the individual and convey that information along with sensor data, if collected, to the portable device 100 and/or the computer 200. This conveyance of the unique ID, location, and any other information can be autonomous, without an action by the individual, the responder, other person or other device. Examples of short-range wireless RF communication networks 11 with which the device 10 and the system can function include (but are not limited to) Bluetooth, ZigBee, Lora and other wireless communication protocols, a passive RFID such as EPC C1G2, HF NFC, UHF NFC, or other frequency NFC. In some designs, a long-range communication network could be used. The wearable device 10 can be identified from a distance by the portable device 100 and/or the computer 200, the distance being, for example, 100 yards, 50 yards. The computer 200 and/or portable device 100, once authenticated, can then communicate the pertinent information from the cloud server 400 and/or a computer 300 for use by the responders.

The wearable device 10 could additionally have Artificial Intelligence (AI) and Machine Learning (ML) algorithms incorporated into the device 10 to, e.g., analyze sensor data and learn/make inferences that could then be communicated to the remainder of the system to enable a better and individualized response for the individual wearing the device 10.

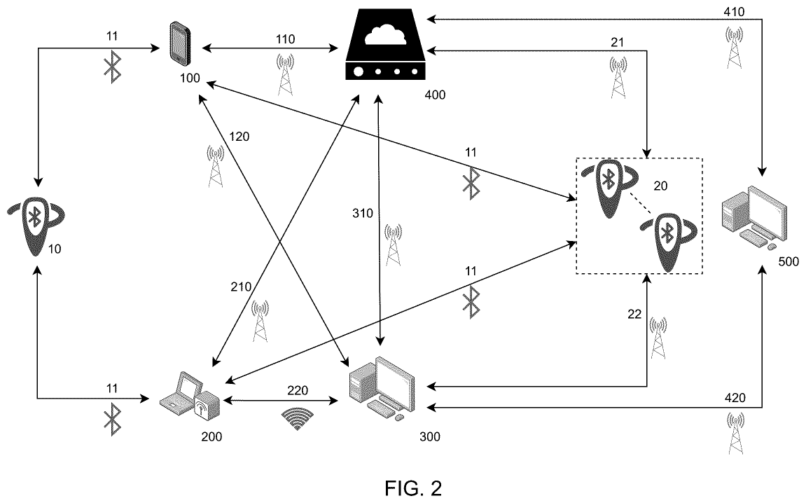

FIG. 2 illustrates an alternate system, similar to that of FIG. 1 in that it includes the wearable device 10, the portable device 100, the computer 200 which could be connected to radio transceivers, the computer 300, the cloud server 400, and the computer system 500, with the same communication network as in FIG. 1. However, the system of FIG. 2 also includes multiple wearable devices 20 with additional communication connections. The multiple wearable devices 20 can have direct communication capability.

As with the wearable device 10, the wearable devices 20 each have a unique ID and uses an established wireless communication network 11 to convey information to the portable device 100 and/or the computer 200. The wearable devices 20 also can gather sensor data, analyze and learn from the sensor data using AI and ML techniques and use an established wireless communication network 21/22 to identify the location of the individual and convey that information to the cloud server 400 and/or the computer 300. Examples of wireless RF communication networks 21/22 with which a wearable device 20 can function can be either short-range or long-range and include (but are not limited to) CDMA/GMS, WiFi (sometimes referred to as WLAN), LTE, 5G, 6G and WiMax. The portable device 100 and/or the computer 200, once authenticated, can then receive the pertinent information from the cloud server 400 and provide the information to the portable device 100 and/or the computer 200 for use by the responders.

The wearable devices 10, 20 are portable, signal-emitting devices configured for placement in and/or on an individual. One or more wearable devices 10, 20 could be attached to or otherwise operably connected to the individual in any of multiple ways such as a bracelet, clothing, shoes, and others. The expectation in the use of these wearable devices is to have an autonomous operation for extended periods of time. The data transmission from the wearable devices 10, 20 can happen periodically i.e., the captured sensor information is transmitted continuously at regular (predetermined) time intervals, or data transmission could be triggered by an event detected by the sensors on the wearable device (e.g., such as a sensor threshold being reached), or the data transmission can happen only when triggered or ‘pinged’, e.g., by the portable device 100, the computer 200, or the cloud server 400. The wearable devices 10, 20 can have the capacity to continue to transmit information for some time period or a certain number of sensor-reads after the trigger has been detected.

The wearable devices 10, 20 include a power source, which may be a single use battery or a rechargeable battery. Examples of suitable batteries include, but not limited to NiCad, lithium, lithium-ion, zinc-carbon, and alkaline batteries. For example, a 3.7V battery could be used, although it is understood that other voltage batteries could be used. Other power source rechargers or regenerators could be utilized, such as an inductive coil, a USB powerline, solar energy, and mechanical energy harvesting mechanisms (e.g., MEMS devices).

The wearable devices 10, 20 could also include a positioning element, such as an assisted GPS or augmented GPS (aGPS) positioning element connected to an antenna, which may be, for example, a planar inverted F antenna, an inverted L antenna, or a monopole antenna. Any antenna may be a multi-band antenna, one that can transmit and receive signals in multiple frequency bands. The GPS positioning element provides data to the wearable devices 10, 20 regarding their physical location.

One or both of the wearable devices 10, 20 transmit information or data, such as its identification and location, via a wireless network 11/21/22; the information or data is provided to portable device 100 or a computer 200 connected to or with built-in radio transceivers. In some embodiments, the wearable devices 10, 20 have two-way communication with the portable device 100 or the computer 200 and/or the cloud server 400 and/or a computer 300. The transmitted information contains digital signatures embedded in the protocol that enable rapid authentication of the wearable device. That is, the wearable devices 10, 20 transmit information (e.g., a ping) and could receive information from the portable device 100 or the computer 200 and/or the cloud server 400 and/or the computer 300. Further, the wearable devices 10, 20 may receive instructions, such as to acknowledge that wearable devices 10, 20 are active and ready to transmit location information and/or other sensory information. Having received those instructions, the wearable devices 10, 20 can send back to the portable device 100, the computer 200, the cloud server 400, or to the computer 300 an acknowledgment that the communication was received and could be configured to provide feedback such as, but not limited to, an audible alert and/or the flashing of a light, or vibration of the device. Every communication exchange is verified for correct transmission (Checksums or Error detection/correction codes could be used for example) and retransmitted if an issue is detected.

The wearable devices 10, 20 can include sensors such as accelerometer(s), gyroscope, galvanic skin resistance (GSR), pulse sensor and/or oxygen sensor (e.g., pulse oximeter), thermometer, and others.

As illustrated in FIG. 1 and FIG. 2, the portable device 100 and/or the computer 200 has two-way communication with the wearable devices 10, 20; that is, the wearable devices 10, 20 can transmit information and receives information from the portable device 100 or the computer 200. The portable device 100 and/or the computer 200 has the ability to rapidly authenticate the wearable devices 10, 20 based on the digital signature that the wearable device transmits. Further, the portable device 100 or the computer 200 will provide information and/or instructions, e.g., via visual and/or audio of the device 100 or the computer 200, or via an augmented reality headset, regarding how to handle the situation and treat the individual effectively and may provide instructions, such as to acknowledge that the wearable devices 10, 20 are active and ready and to transmit the location and any sensor information. Having received that information, portable device 100 or the computer 200 may also provide notification, such as, but not limited to, audible sounds and/or light indications and/or vibration, of how close the responder is to the individual wearing the wearable device or when the individual is in the vicinity.

The portable device 100 or the computer 200 may also possess the ability to rapidly authenticate the wearable devices 10, 20 based on the digital signature of the wearable devices 10, 20.

The portable device 100 and/or the computer 200 could provide the responder with voice command and response capability, via a microphone or a speaker/audio headset.

The portable device 100 and/or the computer 200 may optionally be programmed with Artificial Intelligence (AI) and/or Machine Learning (ML) techniques and capability. This capability could be used, for example, to increase the situational awareness of the responder as well as curate the received information to help increase the efficiency of the response of the emergency personnel. Additionally, for example, this feature could enable handsfree voice querying capabilities independently or in conjunction with the use of the computer 300 and/or the cloud server 400.

As illustrated in FIG. 1 and FIG. 2, the portable device 100 and the computer 200 have two-way communication 110, 210 (respectively) with the cloud server 400, so that the portable device 100 and the computer 200 transmit information and receive information from the cloud server 400, e.g., HIPAA compliant data. The cloud server 400 may provide the individual's information to portable device 100 or the computer 200. The portable device 100 and/or the computer 200 could hold additional data of the individual, such as recently received sensor information. This data, which could be encrypted, may further be transmitted to the cloud server 400 depending on the situation and need. The cloud server 400 may analyze data received from wearable devices 10, 20 directly and/or through the portable device 100 or the computer 200 and from computer 300 and may also possess the ability to rapidly authenticate the wearable devices 10, 20 based on the digital signature of the transmitted signal from the wearable devices 10, 20. Depending on the result and situation, the cloud server 400 may provide information and further instructions to the responder as to how to handle the situation and how to treat the individual. Optionally, the cloud server 400 could also store the data in-lieu of the computer 300 or the data can be synchronized between the computer 300 and the cloud server 400.

As illustrated in FIG. 1 and FIG. 2, the portable device 100 and the computer 200 have two-way communication paths 120, 220 (respectively) with the computer 300 for the exchange of information, e.g., HIPAA compliant data. The computer 300 may provide an individual's information to portable device 100 or the computer 200. The portable device 100 or the computer 200 could hold additional data of the individual such as recently received sensor information. This data, which could be encrypted, may further be transmitted to computer 300 depending on the situation and need. Computer 300 may analyze further data received from wearable devices 10, 20 directly and/or through the portable device 100 or the computer 200 and from the cloud server 400 and may also possess the ability to rapidly authenticate the wearable devices 10, 20 based on the digital signature of the wearable devices' 10/20 transmitted signal/data. Depending on the result, and situation, computer 300 may provide information and further instructions to the responder as to how to handle the situation, and how to treat the individual. Optionally, the computer 300 could also save/store the information/data in-lieu of the cloud server 400 or the data can be synchronized between the computer 300 and the cloud server 400.

As illustrated in FIG. 1 and FIG. 2, the computer 300 has two-way communication 310 with the cloud server 400, potentially also with the portable device 100 or the computer 200 via the communication paths 120, 220, respectively. The computer 300 transmits information and receives information from the cloud server 400, which stores data which could be HIPAA compliant. The cloud server 400 may authenticate all data storage and access and provide alerts and/or rules and/or trends. The cloud server 400 may identify potential issues and may provide/create diagnosis/treatment information by data analysis using methods and techniques such as but not limited to AI, ML, Big Data (BD), Deep Learning (DL), etc. The cloud server 400 can update and/or modify data and add new data fields, e.g., inputted via the computer system 500. The computer 300 could also save/store/replicate the data and perform all the tasks that the cloud server 400 performs in-lieu of the cloud server 400 and/or the data can be synchronized between the computer 300 and the cloud server 400.

The computer 300 and/or the cloud server 400 may be programmed with AI and/or ML techniques and capability. This capability could be used to mine for additional data and learn from other similar cases as well as previous incidents to improve the information provided for improved/better and more meaningful incident response. Capabilities such as LLM (Large Language Models) could be coupled with voice capabilities to provide voice querying as well as handsfree capability to the portable device 100 and/or the computer 200.

As illustrated in FIG. 1 and FIG. 2, the computer system 500 has two-way communication 410 with the cloud server 400 and potentially also with the computer 300 via 2-way communication path 420. Computer system 500 is utilized to make information/data entry and edit to the data stored by the system. All transactions are logged by the system. The cloud server 400 and/or the computer 300 stores data which could be HIPAA compliant. The cloud server 400 and/or the computer 300 may authenticate all data storage and access and provide alerts and/or rules and/or trends. The cloud server 400 and/or the computer 300 may also rapidly authenticate the wearable devices 10, 20 based on the digital signature of the wearable devices 10, 20. The cloud server 400 and/or the computer 300 may identify potential issues by data analysis. The cloud server 400 and/or the computer 300 have the ability to update and/or modify data, add new data fields, and synchronize stored data between the cloud server 400 and the computer 300.

Every communication exchange (e.g., between the cloud server 400 and the computer 300, between computer system 500 and the computer 300, between the computer 200 and the computer 300, etc.,) is verified for correct transmission (checksums or error detection/correction codes could be used, for example) and retransmitted if an issue is detected. Additionally, all transactions are logged by the system. At any stage if the authentication checks fail, access to the system will be prevented and any data transmitted to the system will not be stored or will be discarded. Similarly, if the responder/caregiver authentication checks fail, the data/information is not furnished by the system to the responder.

The wearable device could continuously transmit ID and/or sensor data directly and/or through edge device, e.g., smartphone or portable device and/or computer connected to or equipped with a built-in a radio transceiver. Additionally, the capture of sensor data could be triggered on a timed/periodic basis and/or if there is a sensor value-based triggering event that is detected.

Wearable devices could be built in different formfactors and could have different mounting mechanisms that would allow them to be affixed to the individual's clothes, shoes (for example affixed on the shoelace), etc., be worn as a bracelet or be carried by the individual. The attachment mechanisms described are examples and not limited to those mentioned. Multiple wearable devices could be present on an individual but only one device is required to identify the individual. The system will have the ability to parse multiple IDs and identify the unique individual.

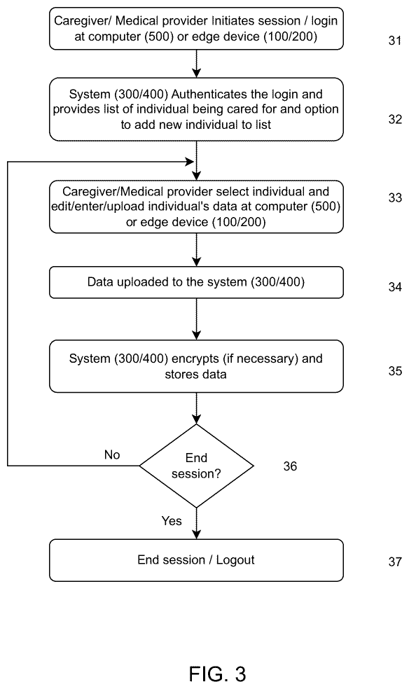

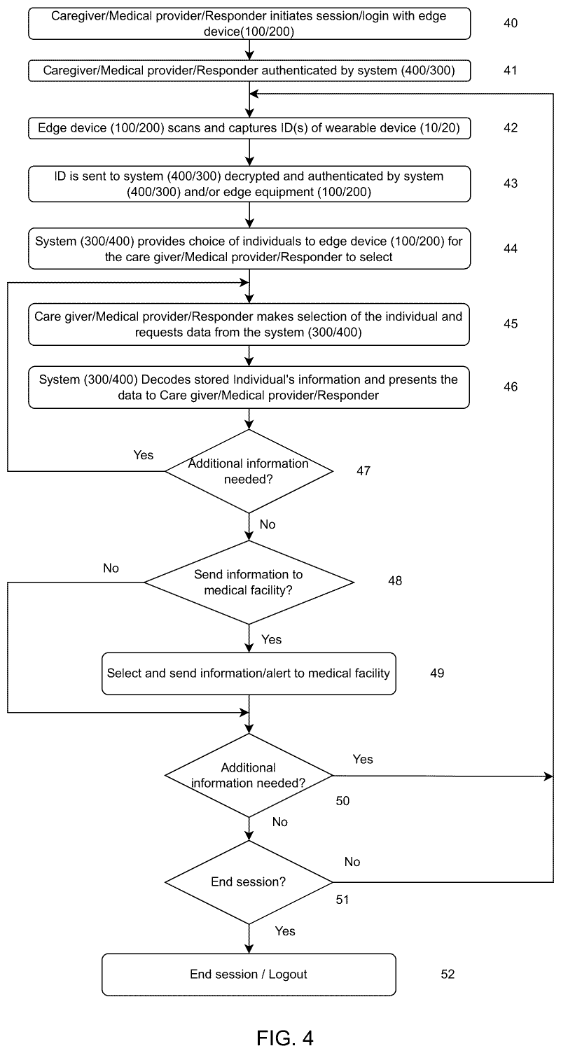

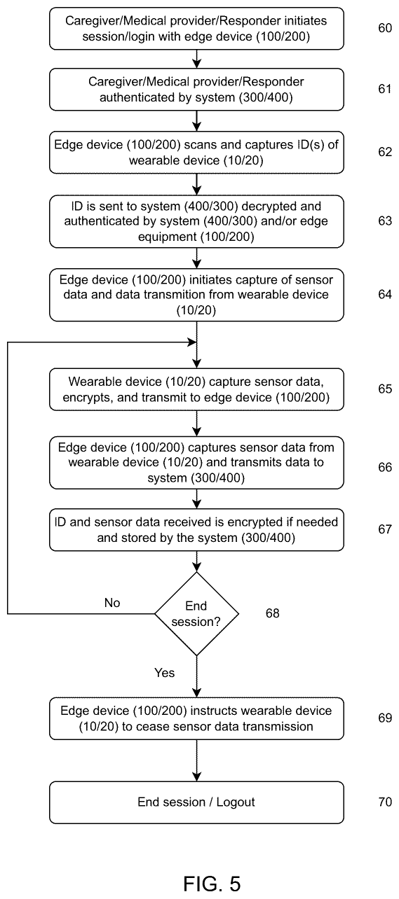

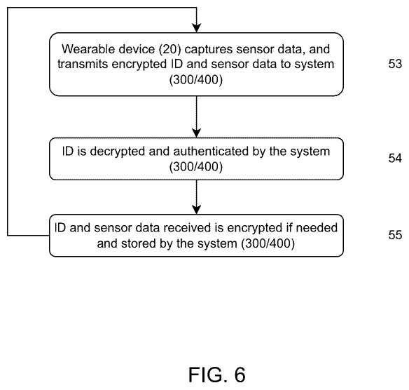

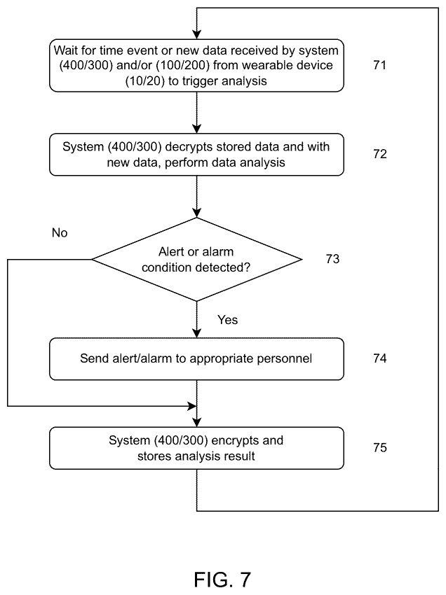

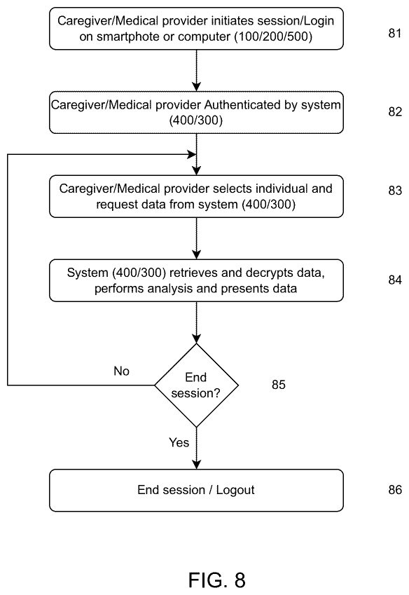

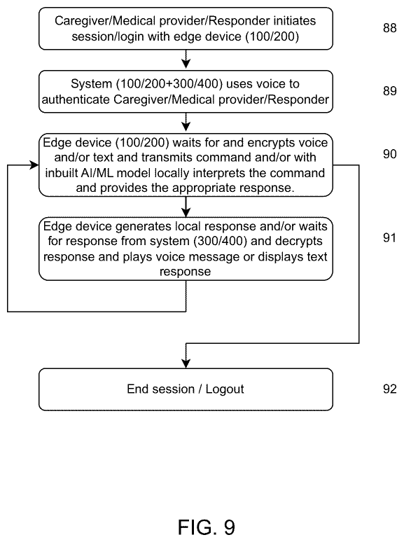

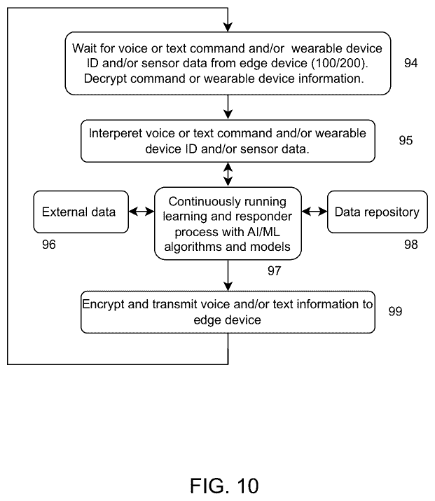

FIG. 3 through FIG. 10 illustrate various flow diagrams, including a data entry process (FIG. 3), a data presentation process (FIG. 4), direct and indirect sensor data capture processes (FIGS. 5 and 6, respectively), a data analysis process (FIG. 7), a data visualization process (FIG. 8), an edge device based AI/ML data exchange and responder interaction process (FIG. 9), and a backend AI/ML and responder interaction process (FIG. 10). The processes described are presented as example processes for the systems of FIG. 1 and FIG. 2 and are non-limiting. There could be additional or alternate processes implemented to create a fully functional system. Any or all of the processes could be run concurrently, and all transactions are logged by the system.

Data transmitted could be encrypted, as necessary; where appropriate, compliance such as HIPAA is observed. At any stage, if an authentication check fails, access to the system is prevented and any data transmitted to the system is not stored or is discarded, and data/information is not provided to the requestor by the system. Every communication exchange is verified for correct transmission (checksums or error detection/correction codes could be used, for example) and retransmitted if an issue is detected.

FIG. 3 illustrates an example of a flow diagram of a data entry process. This data entry process could run concurrently with the other processes in the system that enable the caregiver/medical personnel to feed/edit/add data to the individual's records that they might deem necessary for the responder to effectively help the individual who might be in distress. This data entry process could be run concurrently with any of a data presentation process, direct and indirect sensor data capture processes, a data analysis process, a data visualization process, as well as any other process related to the implementation of the system. This data entry process of FIG. 3 may be repeated, as needed, e.g., adding information to the system as the information becomes available.

The caregiver or medical provider (e.g., doctor, emergency responder, etc.) initiates the session or login to system (step 31) using any of the computer system 500, the portable device 100 or the computer 200. The cloud server 400 or the computer 300 authenticates the login (step 32) and provides the caregiver/medical provider with a list of individuals under the care of the caregiver/medical personnel and/or provides the option to add a new/different individual. In some processes, the list of individuals includes those to which the caregiver/medical provider has been previously been authorized for data entry access. An individual under the care of the caregiver/medical personnel (step 33) is selected, followed by the individual's data being edited and/or new information entered, and the edits are uploaded to the system (step 34) to either the cloud server 400 and/or the computer 300. Either or both the cloud server 400 and the computer 300 encrypt the data, if necessary, and store the data into the system (step 35). Multiple pieces of information can be fed/uploaded into the system with the system providing the data entry person with the option of identifying the level of compliance/security (e.g., HIPAA etc.) that the data needs to be afforded. The caregiver/medical provider has the option to select another individual (step 36) and enter data for that individual using the same process or exit out of the data entry process (step 37).

An individual's information presented to the responder could include treatment suggestions as well as alerts based on analysis performed by the cloud server 400 or the computer 300, e.g., using sensor data provided by the wearable devices 10, 20, through the portable device 100 or the computer 200.

FIG. 4 illustrates an example of the flow diagram of the data presentation. This process can run concurrently with any of the other processes in the system that enable the responder to be presented with the data/information about the individual. This data presentation process could be run concurrently with the data entry process as shown in FIG. 3, direct and indirect sensor data capture processes, a data analysis process, a data visualization process, as well as any other processes of the system.

First, if a caregiver/medical provider/responder (referred to as “responder”) would like to retrieve an individual's data, the responder initiates a session (step 40) using the portable device 100 or the computer 200. The system, through the cloud server 400 or the computer 300, authenticates the login (step 41). Once the login is authenticated, the portable device 100 or the computer 200 scans the wearable devices 10, 20 and captures the ID of one or more of the wearable devices 10, 20 (step 42). The ID(s) are then sent by the portable device 100 or the computer 200 to the system either to the cloud server 400 or the computer 300 and the system will authenticate the ID(s) (step 43). Alternatively, by virtue of the digital signatures embedded in the protocol used, the portable device 100 or the computer 200 can also rapidly authenticate the wearable devices 10, 20. Once the system authenticates the ID(s), it may present a choice of individuals detected based on the IDs transmitted and allow the responder to select the individual in need of assistance (step 44). Once the selection is made and conveyed to the system along with the request for information (step 45), the system decodes the stored data and provides the requested information to the responder (step 46). The responder is provided with the option of requesting other/more information which if the responder so chooses will be provided to the responder (step 47, followed by steps 45 and 46). If no additional information is requested, the system provides the responder the option to transmit the incident related information/notes to another, such as a medical facility or caregiver (step 48), and provides the responder with the option of choosing the information to be sent. Once the information is sent (step 49), the system provides the responder with the option to request information on another individual, if detected by the system (step 50), if the individual's wearable device has been detected. If no additional information is requested, the system provides the responder with the option to exit the system (step 51). If the responder decides to exit the session, the system will close the session (step 52).

FIG. 5 illustrates an example of a flow diagram of an indirect sensor data capture process by the wearable devices 10, 20. This process describes a process that runs concurrently with the other processes in the system that enables the system to capture sensor data from the wearable device using edge devices, e.g., the portable device 100 and/or the computer 200, that are operated by a responder. This indirect sensor data capture processes could be run concurrently with the data entry process as shown in FIG. 3, the data presentation process as shown in FIG. 4, a direct data capture process, a data analysis process, a data visualization process, as well as any other processes.

This indirect sensor data capture process requires the responder to initiate the process by logging in using an edge device e.g., the portable device 100 and/or the computer 200 (step 60) and being authenticated by the system (step 61), e.g., the cloud server 400 and/or the computer 300. The edge device then scans for and captures the ID(s) of the wearable devices 10, 20 within communication distance of the edge device (step 62). The ID is then decrypted and authenticated by the edge device and/or by the system e.g., the cloud server 400 and/or the computer 300 (step 63).

Once the ID is authenticated, the edge device initiates capture of sensor data and transmission of data by wearable devices 10, 20 (step 64). The wearable devices 10, 20 then capture the sensor data, encrypts the data, and transmits the data to the edge device (step 65). The edge device captures the encrypted sensor data and transmits the data to the system (step 66). The system e.g., the cloud server 400 and/or the computer 300, then encrypts, if needed, and stores the received data along with the ID (step 67). The responder has the option to continue to receive data from the wearable devices 10, 20 and transmit the data to the cloud or exit the system (step 68). If the responder chooses to continue receiving data from the wearable device, steps 65, 66, and 67 are repeated. If the responder chooses to end the session, the edge device e.g., portable device 100 and/or computer 200 connected to or equipped with a built-in a radio transceiver, instructs the wearable devices 10, 20 to cease sensor data transmission (step 69) and the system will logout the responder and close the session (step 70).

Sensor data capture could be triggered on a fixed time interval or when the wearable devices 10, 20 detect an event that needs to be reported. There could be multiple combinations of trigger events and sustained data capture after a trigger event occurs.

FIG. 6 illustrates an example of a flow diagram of the autonomous direct sensor data capture for wearable device 20 with a direct communication path 21, 22 as illustrated in FIG. 2. This process describes a process that runs concurrently with the other processes in the system that enables the system to capture the sensor data from the wearable device autonomously without any intervention by caregivers or medical provider or a responder. Wearable devices 20 may have the communications capability to directly communicate with the system e.g., the cloud server 400 and/or the computer 300, using wireless communication paths 21, 22. This direct sensor data capture processes could be run concurrently with data entry process as shown in FIG. 3, data presentation process as shown in FIG. 4, indirect sensor data capture process as shown in FIG. 5, a data analysis process, and a data visualization process, as well as any other processes required for the implementation of the system.

This continuous process is fed the data received by the system, e.g., the cloud server 400 and/or the computer 300, and could be encrypted from the wearable device 20 (step 53). Once the data is received, the ID received is decrypted and authenticated by the system, e.g., the cloud server 400 and/or the computer 300 (step 54). The system, e.g., the cloud server 400 and/or the computer 300 then encrypts, if needed, and stores the received data and waits to receive the next set of data from the wearable device 20 (step 55).

The data transmission from the wearable device can happen periodically i.e., the captured sensor information is transmitted at regular time intervals or data transmission could be triggered by an event detected by the on the wearable device such as a sensor threshold being reached, the device could also have the capacity to continue to transmit information for some time period or a certain number of sensor reads after the trigger has been detected.

FIG. 7 illustrates an example of the flow diagram of the data analysis process. This data analysis process could be run concurrently with data entry process as shown in FIG. 3, data presentation process as shown in FIG. 4, sensor data capture processes as shown in FIG. 5 and FIG. 6, a data visualization process, as well as any other processes. The data analysis process of FIG. 7 is performed by the system, e.g., the cloud server 400 and/or the computer 300, using existing data stored either the cloud server 400 and/or the computer 300, and any new sensor data generated by the wearable devices 10, 20, and collected by an edge device, e.g., portable device 100 and/or the computer 200. A result of this data analysis could include treatment suggestions as well as alerts presented to the responder, caregiver, or medical provider either on the edge device, such as the portable device 100 and/or the computer 200, or the computer 300.

This data analysis process runs continuously. The system, e.g., the cloud server 400 and/or the computer 300, waits for a trigger event to initiate analysis of the data (step 71). The trigger for the analysis could be either a time-based periodic trigger or it could be driven by new data being received by the system through the wearable devices 10, 20. Once the trigger is detected, the system decrypts the stored data along with any new data and performs the data analysis using methods and techniques such as but not limited to AI, ML, BD, DL, etc. (step 72). If the data analysis detects an alert or alarm condition (step 73), the alert and/or alarm is sent to the appropriate person(s), via SMS, text messages, voice, email, etc. (step 74). The system then encrypts the results of the analysis and stores the results for later use (step 75) and goes back into a wait state, waiting for a trigger (step 71). If the data analysis does not detect an alert or alarm condition, the process encrypts and stores the analysis results (step 75) and then returns to the wait state (step 71).

FIG. 8 illustrates an example of a flow diagram of the data visualization process. This process describes a process that enables the caregiver/medical personnel to view the individual's records that they could then use to better help the individual in their care. This data visualization process could be run concurrently with the data entry process as shown in FIG. 3, the data presentation process as shown in FIG. 4, the sensor data capture processes as shown in FIG. 5 and FIG. 6, and the data analysis process as shown in FIG. 7, in addition to any other processes.

This data visualization process of FIG. 8 requires the responder to initiate the process by logging in using an edge device, e.g., the portable device 100 and/or the computer 200, or a computer 500 (step 81) and be authenticated by the system, e.g., the cloud server 400 and/or the computer 300 (step 82). Once authenticated, the responder has the option to choose one of multiple individuals under the care of the caregiver/medical personnel, and request the data from the system, e.g., the cloud server 400 and/or the computer 300 (step 83). The system then retrieves and decrypts the data of the chosen individual, performs analysis, and presents the data with visualizations, graphs, table, suggested treatment and other information as need be. The caregiver/medical personnel is then presented with the option of ending the session or seeking information on another individual in their care (step 85). If the caregiver/medical personnel seeks information on another individual in their care, steps 83 and 84 will be repeated. If the caregiver/medical personnel decides to exit the session, the system will logout the responder and close the session (step 86).

FIG. 9 illustrates an example of a flow diagram of an edge device based AI/ML data exchange and responder interaction process. This process enables the caregiver/medical personnel to view the individual's records by issuing voice or text commands. This data visualization and interaction process could be run concurrently with the data entry process as shown in FIG. 3, the data presentation process as shown in FIG. 4, the sensor data capture processes as shown in FIG. 5 and FIG. 6, the data analysis process as shown in FIG. 7, or the simple data visualization process as shown in FIG. 8, in addition to any other processes.

In this process, the user (e.g., caregiver or medical personnel or responder) initiates the process by logging in using an edge device, e.g., the portable device 100 and/or the computer 200 or a computer 500 (step 88) and is authenticated by the system, e.g., the cloud server 400 and/or the computer 300 and/or portable device 100 and/or the computer 200, using voice signatures (step 89). Once authenticated, the user issues voice or text commands, which the edge device encrypts and transmits to the system with AI/ML support, which could interpret the command locally on the edge device and provide the appropriate information or support that the user is requesting (step 90). The system interacts with the user where the user is presented with the option, through voice or text, to choose, e.g., one of multiple individuals under the care of the caregiver/medical personnel (should multiple individuals be present) and request the data from the system (step 90) which the system then retrieves and decrypts the data of the chosen individual, performs analysis, and presents the data with visualizations, graphs, table, suggested treatment and other information as need be on the edge device (step 91). The user can choose to end the session or seek information on another individual in their care. If the user seeks information on another individual, steps 90 and 91 will be repeated. If the user decides to exit the session, the system will logout the responder and close the session (step 92).

FIG. 10 illustrates an example of a flow diagram of the backend AI/ML and responder interaction process. This process enables the caregiver/medical personnel to query the information database by issuing voice or text commands from an edge device and enables the responder to access the individual's records. This data accessing and AI/ML process could be run concurrently with a data entry process as shown in FIG. 3, a data presentation process as shown in FIG. 4, sensor data capture processes as shown in FIG. 5 and FIG. 6, a data analysis process as shown in FIG. 7, a simple data visualization process as shown in FIG. 8, and an edge device based AI/ML data exchange and responder interaction process as shown in FIG. 9, in addition to any other processes.

The process shown in FIG. 10 has multiple processes that are running continuously and simultaneously when the system is in use. A continuously running learning and responder process (step 97) uses AI and ML to improve the response model and to draw inferences. This process sources data from external sources (step 96) and the data repository (step 98) to refine the stored data and improve the response model.

Another continuously running process in FIG. 10 is the stage (step 94) that waits to receive the voice or text command sent by the edge device, decrypts the command and/or the wearable device information (ID, sensor data) and passes the information to the interpreter stage (step 95) that interprets the command by leveraging the information and algorithms that the AI/ML stage provides (step 97). The response to the interpreted command is then generated by the responder process (step 97) and passed to the next stage (step 99) that encrypts and transmits the information back to the edge device. Once the transmission is completed, the process goes back to waiting for the next command to be received (step 94). The AI/ML stage (step 97) is a continuously running process that collects and analyzes sensor data as well as data from the data repository (98) and external data sources (96) to learn and draw conclusions that could then be used to model and improve the responses provided to the emergency responders. Learning could also be in terms of attempting to preempt or better understand commands issued by and responses provided to responders.

In all the processes discusses above and variations thereof, HIPAA compliance is maintained for all required information/data, such as but not limited to name, picture, physical description of individual, date of birth, home address, phone number, medical condition, emergency contact information, emergency contact name, care instructions/special instructions (e.g., non-verbal, combative, etc.), medical records (test results, diagnoses, MRI/CAT scan reports, etc.), peculiarities of the individual, medication(s), allergies (e.g., to medications, food, other), doctor's name and contact information, and basically any information that the caregiver and/or medical personnel deem important for the wellbeing of the individual.

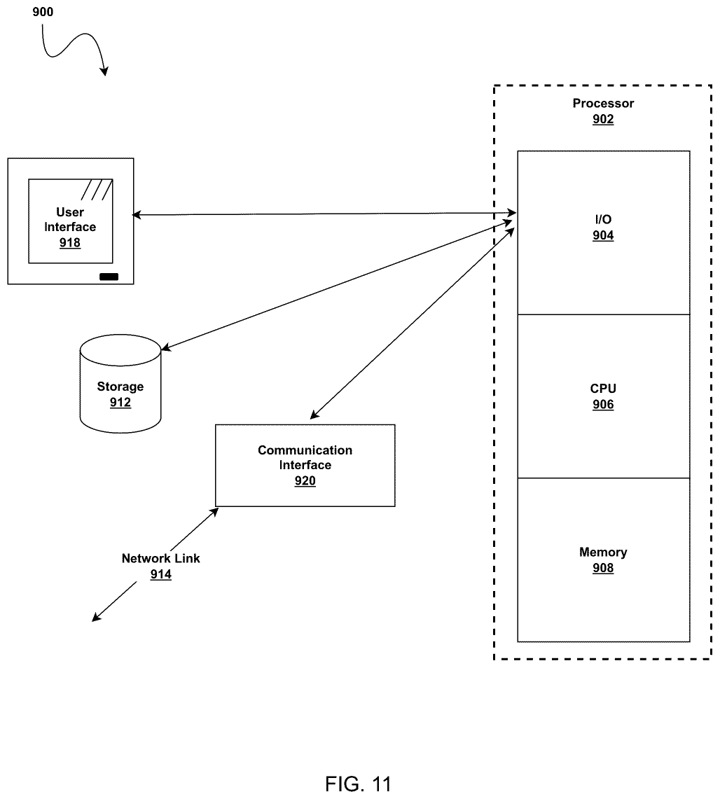

FIG. 11 shows a computer system 900 suitable for implementing one or more processes of a system as described herein such as the various processes of FIGS. 3 through 10. The computer system 900 is capable of executing a computer program product embodied in a tangible computer-readable storage medium to execute a computer process. As used herein, “tangible computer-readable storage media” includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium that can be used to store the desired information and that can be accessed by a computer. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

Data may be input to the computer system 900, which reads the files and executes the programs using one or more processors. Some of the elements of the computer system 900 are shown in FIG. 11; the system 900 has a processor 902 having an input/output (I/O) section 904, a Central Processing Unit (CPU) 906, and a memory 908. There may be one or more processors 902 in the system 900, such that the processor 902 of the computing system 900 comprises a single CPU 906, or a plurality of CPUs 906. The CPUs 902, 906 may be single core or multi-core processors.

The computing system 900 may be a conventional computer, a distributed computer, or any other type of computer. The described technology is optionally implemented in software (modules) loaded in memory 908, a storage unit 912, and/or communicated via a wired or wireless network link 914 on a carrier signal (e.g., Ethernet, 3G wireless, 5G wireless, 6G wireless, LTE (Long Term Evolution)) thereby transforming the computing system 900 in FIG. 11 to a special purpose machine for implementing the described operations.

The I/O section 904 may be connected to one or more user-interface devices (e.g., a keyboard, a touch-screen display unit 918, etc.) or a storage unit 912. Computer program products containing mechanisms to effectuate the systems and methods in accordance with the described technology may reside in the memory 908 or on the storage unit 912 of such a computer system 900.

A communication interface 920 is capable of connecting the computer system 900 to a network via the network link 914, through which the computer system can receive instructions and data embodied in a carrier wave. When used in local area networking (LAN) environment, the computing system 900 is connected (by wired connection or wirelessly) to a local network through the communication interface 920, which is one type of communications device. When used in a wide-area-networking (WAN) environment, the computing system 900 typically includes a modem, a network adapter, or any other type of communications device for establishing communications over the wide area network. In a networked environment, program modules depicted relative to the computing system 900 or portions thereof, may be stored in a remote memory storage device. It is appreciated that the network connections shown are examples of communications devices for and other means of establishing a communications link between the computers may be used.

In an example implementation, any or all of the processes of FIGS. 3 through 10 are embodied by instructions stored in memory 908 and/or the storage unit 912 and executed by the processor 902.

One or more relational databases storing data used in comparing different measurements may be stored in the disc storage unit 912 or other storage locations accessible by the computer system 900. In addition, the computer system 900 may utilize a variety of online analytical processing tools to mine and process data from the databases. Further, local computing systems, remote data sources and/or services, and other associated logic represent firmware, hardware, and/or software, which may be configured to characterize and compare different locales. A monitoring system of this disclosure can be implemented using a general purpose computer and specialized software (such as a server executing service software), a special purpose computing system and specialized software (such as a mobile device or network appliance executing service software), or other computing configurations. In addition, any or all of the module(s) may be stored in the memory 908 and/or the storage unit 912 and executed by the processor 902.

The implementations described herein are implemented as logical steps in one or more computer systems. The logical operations of the present invention are implemented (1) as a sequence of processor-implemented steps executing in one or more computer systems and (2) as interconnected machines or circuit modules within one or more computer systems. The implementation is a matter of choice, dependent on the performance requirements of the computer system implementing the invention. Accordingly, the logical operations making up the implementations described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and devices, it is to be understood that the invention defined in the appended claims is not necessarily limited to the specific structures and devices described. Rather, the specific aspects are described as forms of implementing the claimed invention. Because many embodiments of the invention can be practiced without departing from the spirit and scope of the invention, the invention resides in the claims hereinafter appended.

Various features and details have been provided in the multiple designs described above. It is to be understood that any features or details of one design may be utilized for any other design, unless contrary to the construction or configuration. Any variations may be made.

The above specification and examples provide a complete description of the systems and processes and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Thus, various embodiments of the system for identifying individuals and corresponding condition(s) are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. An identification system comprising
a wearable device encoding a unique ID and having a wireless transmitter for transmitting the unique ID;
a backend device having a memory for storing data, a processor for analysis of the data, and a transceiver configured to communicate the data, the data comprising relevant information for an individual tied to the unique ID; and
a portable device having a wireless transceiver configured to receive via wireless transmission the unique ID from the wearable device and to receive the relevant information via wireless data transmission from the backend device.

2. The system of claim 1 wherein the wireless transmitter of the wearable device utilizes a short-range wireless RF communication network.

3. The system of claim 2, wherein the short-range wireless RF communication network utilizes a Bluetooth, ZigBee, Lora or other short-range protocol.

4. The system of claim 1, wherein the portable device utilizes a short-range wireless RF communication network and a long-range wireless RF communication network.

5. The system of claim 4, wherein the short-range wireless RF communication network utilizes a Bluetooth, ZigBee, Lora or other short-range protocol, and the long-range wireless RF communication network utilizes CDMA/GMS, WiFi or WLAN, LTE, 5G, 6G, WiMax or other long-range protocol.

6. The system of claim 1, wherein one or more of the wearable device, portable device and backend device includes Artificial Intelligence and/or Machine Learning capabilities.

7. The system of claim 1, wherein the portable device is a smartphone, tablet, portable computer, or augmented reality headset.

8. The system of claim 1, wherein the backend device has a cloud-based memory.

9. The system of claim 1, wherein the backend device is a computer remote from the wearable device and remote from the portable device.

10. The system of claim 1 further comprising a data entry computer separate from the backend device, the data entry computer operably connected to the backend device to send the data to the backend device.

11. The system of claim 1, wherein the wearable device is configured to autonomously transmit the unique ID to the portable device when the portable device is within a predetermined distance of the wearable device.

12. A method of a responder interacting with an individual, the method comprising:
inputting relevant information for the individual into a backend device having a memory storing the relevant information;
autonomously receiving at a portable device a unique ID from a wearable device associated with the individual when the portable device is physically within a predetermined distance of the wearable device;
after receiving the unique ID, the portable device contacting the backend device and receiving the relevant information for the individual from the backend device; and
after the portable device receiving the relevant information, the portable device presenting the relevant information to the responder.

13. The method of claim 12, wherein:
the portable device presents the relevant information to the responder after receiving a command from the responder.

14. The method of claim 13, wherein:
the portable device presents the relevant information to the responder after receiving a verbal command from the responder.

15. The method of claim 13, wherein inputting the relevant information for the individual into the backend device comprises:
inputting the relevant information into a data entry computer operably connected to the backend device.
